(19) United States
(12) Patent Application Publication
(10) Pub. No.: US 2013/0325202 A1
(43) Pub. Date: Dec. 5, 2013

(54) NEURO-COGNITIVE DRIVER STATE PROCESSING

(71) Applicants: Michael D. HOWARD, Westlake Village, CA (US); Rajan BHATTACHARYYA, Sherman Oaks, CA (US); Michael J. DAILY, Thousand Oaks, CA (US)

(72) Inventors: Michael D. HOWARD, Westlake Village, CA (US); Rajan BHATTACHARYYA, Sherman Oaks, CA (US); Michael J. DAILY, Thousand Oaks, CA (US)

(73) Assignee: GM GLOBAL TECHNOLOGY OPERATIONS LLC, Detroit, MI (US)

(21) Appl. No.: 13/486,224

(22) Filed: Jun. 1, 2012

(51) Int. Cl. B60K 28/00

(52) U.S. Cl. 701/1

(57) ABSTRACT

A driver state module for interfacing with a vehicle, with a surroundings vicinity of the vehicle and with a driver of the vehicle, the driver state module comprising: (i) a frame memory for storing representations of behaviors with related context; (ii) an evaluation system for ranking the frames based on goals and rewards; (iii) a working memory comprising a foreground sub-memory and a background sub-memory, the working memory for holding and sorting frames into foreground and background frames, and (iv) a recognition processor for identifying salient features relevant to a frame in the foreground memory ranked highest by the evaluation system.

### BACKGROUND

Vehicle collisions are often attributable, at least partially, to the driver's behavior, visual and auditory acuity, decision-making ability, and reaction speed. A 1985 report based on British and American crash data found driver error, intoxication and other human factors contribute wholly or partly to about 93% of crashes.

In general, a better understanding of what human causes contribute to accidents may help develop systems that aid drivers in avoiding collisions.

### SUMMARY OF THE INVENTION

According to an example of the invention there is provided a driver state module for interfacing with a vehicle, with a surrounding vicinity of the vehicle and with a driver of the vehicle, the driver state module comprising: (i) a frame memory for storing representations of behaviors with related context; (ii) an evaluation system for ranking the frames based on goals and rewards; (iii) a working memory comprising a foreground sub-memory, a background sub-memory and a control for sorting frames into the foreground sub-memory or the background sub-memory, and (iv) a recognition processor for identifying salient features relevant to a frame in the foreground sub-memory or the background sub-memory ranked highest by the evaluation system.

The driver state module may be configured for modeling the focus of attention and awareness of the driver and for predicting imminent actions of the driver.

According to some examples, the interfacing with the vehicle, the surrounding vicinity of the vehicle and the driver of the vehicle may be via sensors.

In some examples, the driver state module may be mounted in a vehicle.

According to an example, a driver assistance system for assisting a driver of a vehicle within a surrounding vicinity of the vehicle, may include: (i) the driver state module; (ii) a vehicle state module for describing the state of the vehicle in the surrounding vicinity; (iii) a mismatch detection module for comparing the driver state module and the vehicle state module and for assessing whether there is a mismatch between the driver state module and the vehicle state module; (iv) a driver associate interface module for determining a required action if the vehicle state module detects a mismatch, and (v) a sensor pre-processing module for fusing data from a plurality of sensors on the vehicle and for outputting fused data in formats appropriate to each module.

In some examples, the driver state module may include (i) a frame memory for storing representations of behaviors with related context; (ii) an evaluation system for ranking the frames based on goals and rewards; (iii) a working memory comprising a foreground sub-memory, a background sub-memory and a control for sorting frames into the foreground sub-memory or the background sub-memory, and (iv) a recognition processor for identifying salient features relevant to a frame in the foreground sub-memory or the background sub-memory ranked highest by the evaluation system.

According to some examples, the driver assistance system may be configured for various applications including at least one of: (i) controlling the vehicle for short periods of time whilst the driver is distracted; (ii) semi-autonomous controlling of the vehicle; (iii) receiving feedback from driver behavior for self-learning by experience; (iv) learning driving characteristics of a particular driver to optimize response to the particular driver; (v) modeling focus of attention and awareness of the driver and (vi) predicting imminent actions of the driver.

In some examples, the plurality of sensors may include at least one vehicle sensor for sensing vehicle related parameters. The vehicle sensor may be selected from the group consisting of sensors for sensing vehicle speed, engine temperature, fuel level, engine revolutions (e.g. rpm), sensors that note whether windscreen wipers are deployed, sensors that note whether lights are deployed, sensors that note whether hazard systems are deployed, sensors that note the position of the steering wheel, etc.

In some examples, the plurality of sensors may include at least one driver sensor for sensing driver related parameters. The driver sensor may be selected from the group consisting of sensors for sensing the driver's awareness, cameras providing feedback of driver's alertness from nodding, cameras providing feedback of driver's alertness from eye closing, eye trackers for tracking driver's attention from direction of gaze, steering wheel mounted pressure sensors, galvanic skin response sensors for monitoring perspiration and electroencephalography sensors.

In some examples, the plurality of sensors may include at least one vicinity sensor for sensing variables relating to a surrounding vicinity of the vehicle. The vicinity sensor may be selected from the group consisting of forward looking cameras, lane following sensors, distance sensors deployed in all directions to determine distance of nearby objects, such as radar, LIDAR (Light Detection And Ranging), sonar, IR sensors, general position sensors, GPS, ambient temperature sensors and ambient light sensors.

According to some examples, the driver assistance system may be configured for use in at least one application selected from the group consisting of semi-autonomous control, accident prevention, alerting, education, driver simulation and vehicle design optimization.

In some examples the driver assistance system may be integral to a vehicle or retrofitted to the vehicle.

According to some examples a computer software product may be provided that includes a medium readable by a processor, the medium having stored thereon: (i) a first set of instructions for storing representations of behaviors with related context as frames in a memory; (ii) a second set of instructions for ranking the frames based on goals and rewards; (iii) a third set of instructions for holding and sorting the frames into foreground frames and background frames, and (iv) a fourth set of instructions for identifying salient features relevant to a foreground frame having a highest ranking.

According to some examples a computer software product may be provided that includes a medium readable by a processor, the medium having stored thereon a set of instructions for assisting a driver of a vehicle within a surrounding vicinity of the vehicle, comprising: (a) a first set of instructions which, when loaded into main memory and executed by a processor models the focus of attention and awareness of the driver for predicting imminent actions of the driver; (b) a second set of instructions which, when loaded into main memory and executed by a processor describe the state of the vehicle in the surrounding vicinity; (c) a third set of instructions which, when loaded into main memory and executed by a processor describe comparing results obtained from the first and second sets of instructions for assessing whether there is a mismatch requiring further action; (d) a fourth set of instructions which, when loaded into main memory and executed by a processor determine the required action if running the third set of instructions detects a mismatch, and (e) a fifth set of instructions which, when loaded into main memory and executed by a processor, fuse data from a plurality of sensors on the vehicle and outputs the fused data in formats appropriate to each of first, second, third and fourth sets of instructions.

An example is directed to a method for interfacing with a vehicle, with a surrounding vicinity of the vehicle and with a driver of the vehicle, comprising: (i) storing representations of driver behaviors with related context as frames in a frame memory; (ii) ranking the frames based on goals and rewards; (iii) a working memory comprising holding and sorting frames into a foreground sub-memory or background sub-memory, and (iv) identifying salient features relevant to the frame with a highest ranking.

An example is directed to a method for processing sensor inputs from a plurality of sensors on a vehicle relating to a driver, the vehicle and a surrounding vicinity, the method comprising: (i) fusing data from the plurality of sensors and outputting the fused data in appropriate formats; (ii) modeling the focus of attention and awareness of the driver for predicting imminent actions of the driver; (iii) describing a state of the vehicle in its surrounding vicinity; (iv) comparing results obtained from the predicted imminent actions and the state of the vehicle to determine mismatches; (v) assessing whether there is a mismatch requiring further action, and (vi) determining the required action if a mismatch is detected.

### BRIEF DESCRIPTION OF THE DRAWINGS

The subject matter regarded as the invention is particularly pointed out and distinctly claimed in the concluding portion of the specification. Examples are described in the following detailed description and illustrated in the accompanying drawings in which:

FIG. 1 is schematic illustration of a car, it's driver and the surrounding vicinity;

FIG. 2 is a conceptual block diagram of the core modules of one example of a driver assistance system, for interfacing directly with a vehicle and with the driver;

FIG. 3 is a conceptual block diagram showing the conceptual parts of the driver state processing module of FIG. 2, according to examples of the invention;

FIG. 4 is biological model of the neuro-cognitive structure and function of the human brain's control and processing, that serves as the inspiration and conceptual justification for the module of FIG. 3, and

FIG. 5 is a conceptual block diagram and flowchart of a method for processing sensor inputs according to an example of the present invention.

Where considered appropriate, reference numerals may be repeated among the figures to indicate corresponding or analogous elements.

### DETAILED DESCRIPTION

In the following detailed description, numerous specific details are set forth in order to provide a thorough understanding of examples of the invention. However, it will be understood by those of ordinary skill in the art that the examples of the present invention may be practiced without these specific details. In other instances, well-known methods, procedures, components, and circuits have not been described in detail so as not to obscure the present invention.

Unless specifically stated otherwise, as apparent from the following discussions, throughout the specification discussions utilizing terms such as “processing”, “computing”, “storing”, “determining”, or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Accidents may happen when hazardous road or traffic conditions are not obvious at a glance, or where the conditions are too complicated for the driver to perceive and react in the time and distance available.

Controlling a vehicle on the road is complicated by distractions such as mobile phones and passengers, and by the ever greater density of other road users including both traffic and pedestrians.

There are demographic differences in crash rates. For example, although young people tend to have good reaction times, disproportionately more young male drivers are involved in accidents, with researchers observing that many exhibit behaviors and attitudes to risk that can place them in more hazardous situations than other road users. Older drivers with slower reactions might be expected to be involved in more accidents, but this has not been the case as they tend to drive less and, apparently, more cautiously. Though a mere 10% of the population, surprisingly, left handed drivers are involved in some 45% of vehicle collisions.

However, many locations that appear dangerous have few or no accidents. Conversely, a road that does not look dangerous may have a high crash frequency. This is, in part, because if drivers perceive a location as hazardous, they take more care.

Sometimes improvements to car design do not lead to significant improvement in performance. Improved brake systems may result in more aggressive driving, and compulsory seat belt laws have not been accompanied by a clearly attributed fall in overall fatalities.

The term “vehicle” as used herein includes all modes of transportation having an onboard driver, including airplanes, trains and boats, but particularly various cars, trucks and lorries.

The word “car” as used herein is synonymous with automobile.

According to examples, an improved human-machine interface for a vehicle is provided. In some examples, semi-autonomous vehicle control is enabled. More specifically, a driver state module for modeling behavior of the driver of a vehicle is described herein below. The driver's state module models the focus of the driver's attention and awareness, and predicts his imminent actions. The driver state module may be incorporated within a driver assistance system that receives sensory input concerning the driver, the vehicle and the surroundings and predicts the driver's state. Examples may control the vehicle for extended periods of time by maintaining safe operation (e.g., maintaining the vehicle within the lane, safe distance to other cars, avoiding obstacles, etc). This capability means the driver is not currently controlling the vehicle. Other examples may be used for education, driver simulation, and in car design applications.

Although somewhat novel to neuroscience, in psychology, thought processes are sometimes thought of in terms of being in the front of or the back of one's mind. Thus by way of example, a driver of a vehicle may be thinking about something else entirely, such as a discussion held earlier with a spouse or a colleague. The driver is aware of the road and the surroundings, but his attention is elsewhere. If something passes in front of the vehicle, such as a child, for example, the driver's attention will switch to the child. The child is assigned higher priority and considered by the foreground memory, and the argument is pushed backwards, to the background memory. Once the child has safely passed, the awareness thereof is reduced from prominence and later forgotten from the driver's memory, freeing up the driver's attention to consider the argument again.

According to some examples, changes, parameters and variables relating to the driver, the vehicle and the surroundings may be detected and prioritized, to model the driver's response. When installed in a vehicle, the driver state module and driver assistance system may alert the driver or may over-ride the driver control, for example by automatically braking if necessary. Other examples such as those that may be used in a simulator, may serve other purposes. For example, simulator examples may be used to aid selection of the appropriate vehicle for a particular driver.

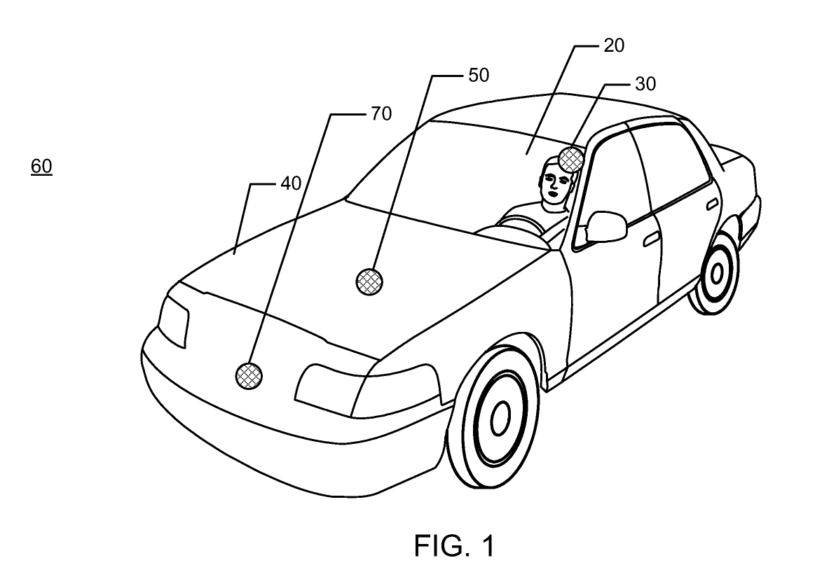

With reference to FIG. 1, a driver 20 of a vehicle 40 in its surroundings 60 is shown.

The vehicle 40 is generally provided with at least one and preferably a plurality of driver sensors 30 for sensing variables and parameters relating to the driver 20, such as the driver's general awareness, for example. Driver sensors 30 may include cameras providing feedback of driver's alertness from nodding or eye closing, and the like. For example, driver sensors 30 may include an eye tracker for tracking the driver's attention by the direction in which he is looking.

Driver sensors 30 may include steering wheel mounted pressure sensors and galvanic skin response sensors for monitoring perspiration thereby providing an indication of the driver's stress level. Driver sensors 30 may include other neural correlating sensors. For example, as an aid for choosing an appropriate vehicle for a driver or for vehicle design purposes, for example, in simulator applications, driver sensors 30 may include electroencephalography (EEG) sensor, allowing the measuring of electrical activity along the scalp to be used to measures voltage fluctuations resulting from ionic current flows within the neurons of the brain.

Driver sensors 30 may include tactile strain sensors on the steering wheel for sensing driver 20 stress.

The vehicle 40 is provided with at least one vehicle sensor 50 and preferably an array of vehicle sensors for sensing the state of the vehicle 40, including, inter alia, speed gauges, engine temperature gauges, fuel gauges, rev counters, and the like.

Vehicle sensors 50 may also include sensors that note whether windscreen wipers, lights and other hazard systems are deployed, and the position of the steering wheel. It will be appreciated that such sensors not only provide information regarding the vehicle 40 but may also provide information regarding the driver 20 and the surroundings 60.

The vehicle 40 is also generally provided with vicinity sensors 70 for sensing the immediate surroundings 60, or vicinity of the vehicle 40. Such vicinity sensors 70 may provide data regarding externalities such as the state of the road and nearby objects, including other vehicles and pedestrians, and may include a forward looking camera, lane following sensors, distance sensors deployed in all directions to determine the distance to nearby objects.

Vicinity sensors 70 may include sensors for sensing nearby objects that work using a variety of enabling technologies, such as radar, LIDAR, sonar, forward looking cameras and IR sensors. Vicinity sensors 70 may also include general positioning sensors such as GPS, and other types of sensors for sensing parameters relating to the surroundings, including ambient temperature sensors, ambient light sensors and the like.

Sensors relating to driver's ability to stay in lane or for detecting swerving of the vehicle 40 may be provided. These sensors may provide information regarding the alertness level of the driver 20 and/or the condition of the vehicle 40. The act of driving involves controlling the vehicle 40 responsive to the environment 60, and, acceleration and deceleration, absolute speed, swerving and skidding, are all easily determined responses to the state of the driver 20, vehicle 40 and environment 60. It will thus be appreciated that although the above sensors, which are provided by way of example only, are categorized into driver sensors 30, vehicle sensors 50 and vicinity sensors 70, this categorization is somewhat arbitrary, and the same sensor may provide information regarding two or more of the driver 20, vehicle 40 and surrounding vicinity 60. Additionally, some of the sensors may be related to auto cruise control ACC, lane departure systems, and semi-autonomous systems that control the operation of the vehicle.

Other senses may sense input that may relate to usage of mobile phone and other internal distractions.

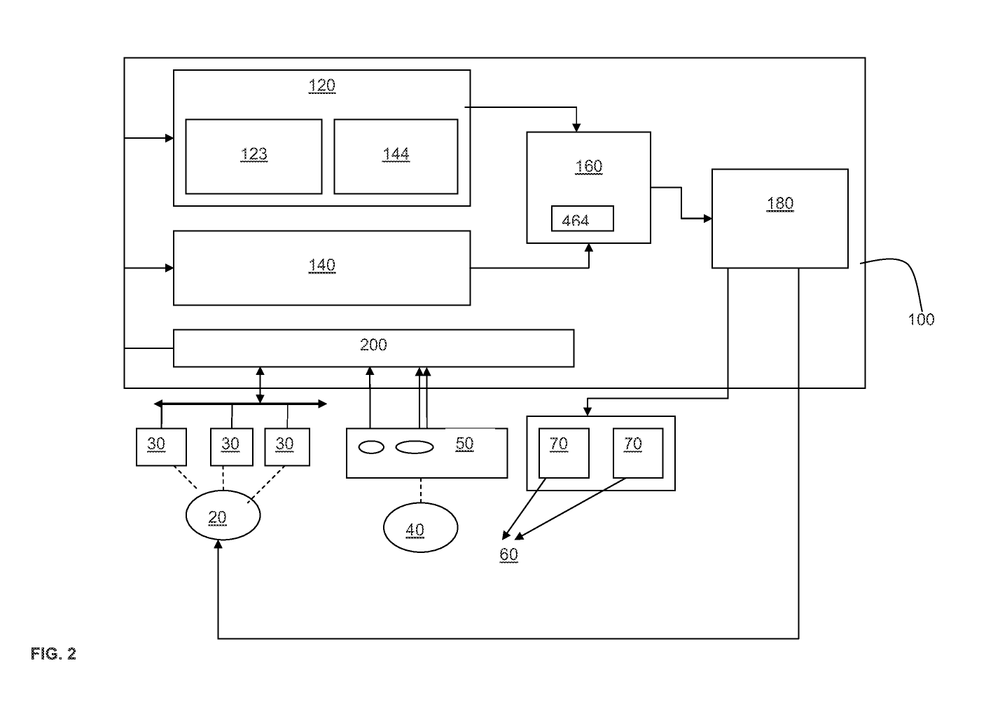

With reference to FIG. 2, a driver assistance system 100 in accordance with an example is shown. The driver assistance system 100 contains five modules: (i) a driver state module 120 which models the focus of a driver's 20 attention and awareness, and predicts his imminent actions; (ii) a vehicle state module 140 which describes the state of the vehicle 40 in the world; (iii) a mismatch detection module 160 which compares the driver state module 120 and the vehicle state module 140 to assess whether there is something that requires alerting the driver 20; (iv) a driver associate interface module 180 that determines the action required if the vehicle state module 140 detects a mismatch, and (v) a sensor pre-processing module 200 that fuses data from multiple sensors on the vehicle 40, generally including driver sensors 30, vehicle sensors 50 and vicinity sensors 70, and outputs it in formats appropriate to each module. The modules, when taken together, make up a semi-autonomous driver assistance system 100 that, when mounted in a host vehicle 40 is capable of semi-autonomously controlling the vehicle 40 for short periods of time whilst the driver 20 is distracted. Furthermore, the autonomous driver assistance system 100 is capable to learn based on feedback relating to the behavior of the driver 20 and to be personalized to a particular driver 20.

The sensor pre-processing module 200 may receive input from three groups of sensors:

(a) driver sensors 30 providing information regarding the driver 20

(b) vehicle sensors 50 concerning the vehicle 40

(c) vicinity sensors 70 that provide details regarding the surrounding environment 60 of the vehicle 40, such as the state of the road and nearby objects

Examples of such sensors are given hereinabove.

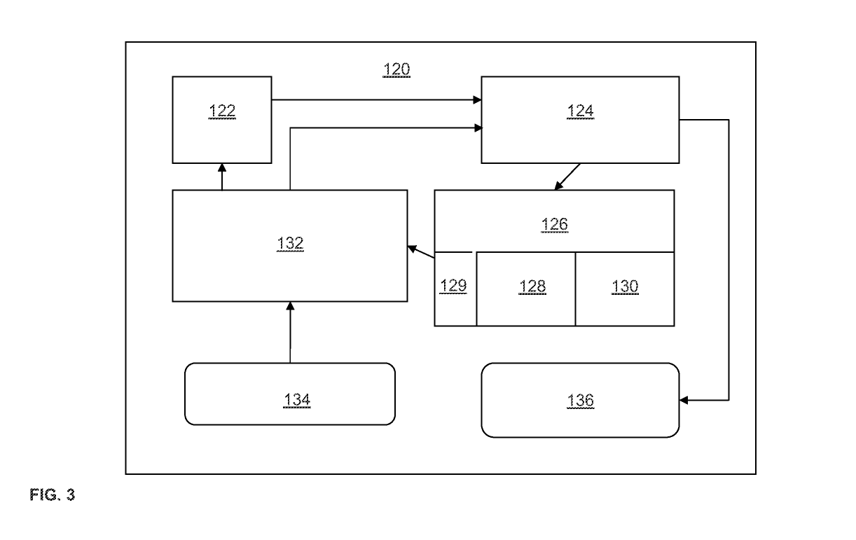

With reference to FIG. 3, the driver state module 120 includes the following components and sub-systems: (i) a frame memory 122 which may store representations of behaviors with related context; (ii) an evaluation system 124 which may rank the frames based on goals and rewards, (iii) a working memory 126 that includes control 129 for holding and sorting frames into foreground sub-memories 128 and background sub-memories 130, and (iv) a recognition preprocessor 132 that may identify salient features relevant to the highest ranked frame in the foreground memory 128.

The driver state module 120 may interface with the environment 60 using an environmental interface 134 which may receive input regarding the environment 60, and may provide, as output 136, behavior likelihoods and reaction times for the driver 20.

The driver state module 120 of FIG. 3 is suitable for inclusion as part of a larger driver assistance system, such as that shown in FIG. 2.

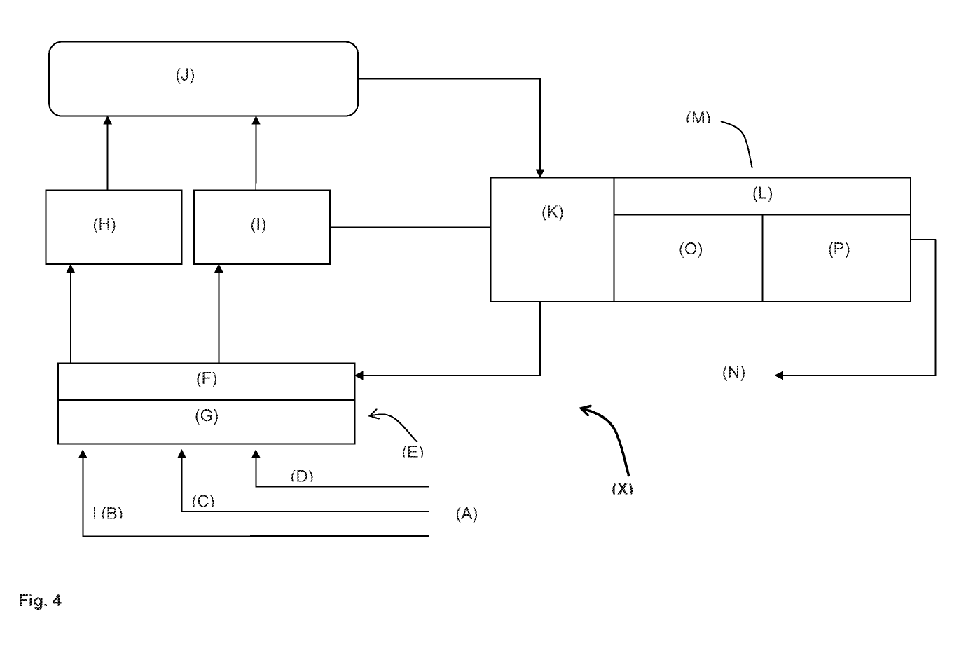

In general, the driver state module 120 uses a neuro-cognitive approach modeled on the structure and function of the brain regions involved in attention and executive control of behavior. To facilitate understanding the behavior and functionality of the driver state module 120 in accordance with one example, reference is made to FIG. 4 where a biological model is shown.

Referring now to FIG. 4, a biological inspiration for examples of the driver state module 120 is a detailed model of the neuro-cognitive structure and function of the human brain's executive control (144, FIG. 3) and attentional networks (123, FIG. 3), making it a good predictor of human biases and distraction in novel driving situations. Thus it will be appreciated that FIG. 4 is essentially an abstraction of key parts of the driver state module 120 of FIG. 3, and the driver state module 120 can be considered as a physical example of the theoretical model of FIG. 4.

FIG. 4 is thus a cognitive model of a driver 20, providing driver state analysis (i.e., likelihoods on current foreground and background behaviors guiding the driver's current and imminent future actions) using a neuro-cognitive model that outputs driver behavior.

According to examples, the driver state module and driver assistance system of FIGS. 2 and 3 may use a conceptually analogous system modeled on the cognitive model of FIG. 4. It will, therefore, be appreciated that the systems shown in FIGS. 2 and 3 may embody an approach to semi-autonomous driving of a vehicle 40 in response to output from the driver state module 120 that is differentiated from previous approaches by its unprecedented detailed model of the structure and function of the brain regions involved in attention and executive control of behavior.

Drivers 20, like other humans, receive visual, audible and tactile sensory input relating to their environment 60, i.e. their surroundings or vicinity.

The cognitive model shown in FIG. 4 shows how sensory input A consisting of visual B, audible C and tactile D input are received. The sensory input A may be recognized by a recognizer E consisting of top down bias filters F and bottom up saliency filters G

The input may be classified by a classifier H which generally uses ventral parts of the brain to determine “what” and a locator I which uses dorsal parts of the brain to determine “where”, generally using the parietal lobe to integrate sensory information from different modalities, particularly determining spatial sense and navigation. This enables regions of the parietal cortex to map objects perceived visually into body coordinate positions. The locator I thus fuses the sensed data into a picture of the location or surroundings, i.e. the driver's vicinity (60 FIG. 1).

Output from both the classifier H and the locator I may be fed into a long term memory J which may then provide data to a comparator K for comparing the reality with the driver's 20 plans. The locator I may also directly provide alerts to the comparator K where something is amiss.

The comparator K together with a behavior selector L may make up an evaluator M and may provide behavioral output N. The behavior selector L generally selects and classifies behaviors into foreground behaviors O which are stored in the prefrontal cortex working memory and into background behaviors P. Foreground behavior O from the prefrontal cortex working memory is fed back to the top down bias filter F for top-down biasing.

The saliency of sensed data may relate to the state or quality by which it stands out relative to the background. Saliency detection may be considered as being a key attentional mechanism that may facilitate learning and survival by enabling organisms to focus their limited perceptual and cognitive resources on the most pertinent subset of the available sensory data A, including visual B, audible C and tactile D sensory data.

In the brain, as modeled in FIG. 4, the working memory L may be considered as including both foreground O and background P working memory. The working memory L is dynamically updated by the anterior cingulate cortex and gated by the basal ganglia, thereby keeping the highest rated behaviors in the foreground working memory. In the model, based on the latest neuro-cognitive theories of prefrontal cortex, the foreground working memory O stores behaviors that have special access to attentional resources. The background working memory P stores potentially relevant lower utility behaviors with limited ability to martial attention.

When attention deployment is driven by salient stimuli, it is considered to be bottom-up, memory-free, and reactive.

Attention can, however, also be guided by top-down, memory-dependent, or anticipatory mechanisms, such as when looking ahead of moving objects or sideways before crossing streets. It will be appreciated that humans in general, and drivers 20 in particular, cannot pay attention to more than one or very few items simultaneously, so they are faced with the challenge of continuously integrating and prioritizing different bottom-up and top-down influences.

Referring back to FIG. 2, in some examples, the driver state module 120 may learn to adapt its responses to the driver 20 via executive control 144, based on feedback from driver 20 behavior supplied through the sensor preprocessing module 200 and includes a utility computer 464 for learning how to assign utilities to associations between situational context and behavior: for personalizing to a particular driver 20.

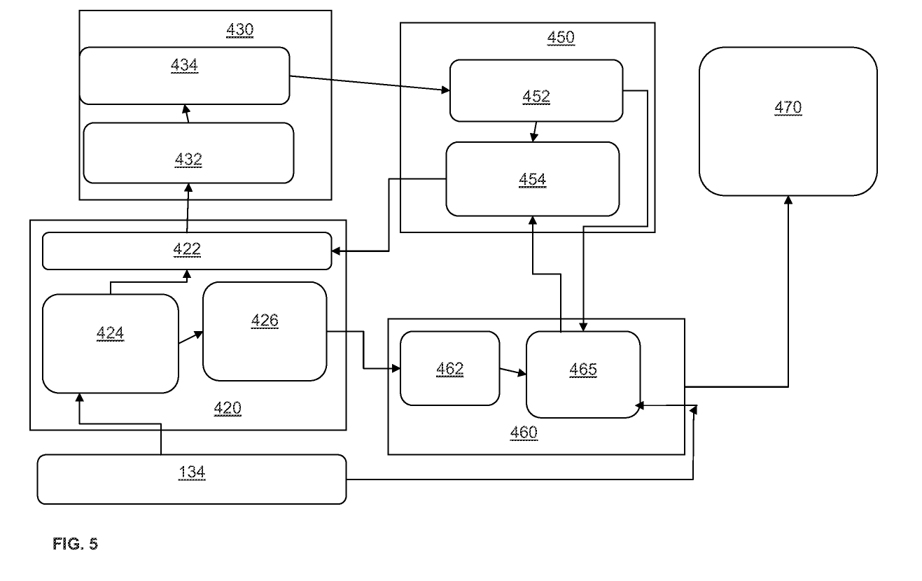

With reference to FIG. 5, a conceptual block diagram integrated flowchart 500, corresponding to the modules of FIG. 3 is presented. The conceptual block diagram integrated flowchart 500 shows where each process may take place. The process of the invention may generally operate as a closed loop, continually sensing and evaluating the situation, i.e. the condition of the driver 20, vehicle 40 and surroundings 60, and having an output to the vehicle 40 or driver 20 for optimizing the interaction with the environment 60.

Periodically or continuously, the driver sensors 30, vehicle sensors 50, vicinity sensors 70 that make up the environmental interface 134 provide input to the recognition preprocessing module 420 which may filter the output from the various sensors 30, 50, 70 and may deliver output concerning the driver state and vehicle state to the respective driver and vehicle state modules shown in FIG. 2. The filtering may be quite complex. Some filtering may be performed by a top down biasing filter 422 that follows a top down biasing model which is goal oriented. Other filtering may be performed by a bottom-up saliency filter 424 that recognizes salient features from the sensor input of the environmental interface 410. The recognition preprocessing module 420 may also generates attention alerts 426 that may be sent to an alert handler 462 of the evaluator 460 which may handle these alerts.

Output from the recognition preprocessing module 420 may be sent to the frame memory 430 which updates the frame activation 432 and may report relevant frames 434. This may link to the working memory 450 which may include a linker 452 for linking to active frames and a sensing priority extractor 454 for extracting sensing priorities, which may feed back to the top down bias filter 422. The linker 452 may also provide a signal to the ranker 465 of the evaluating system 460 which may rank sensor input from the sensors 30, 50, 70 and alerts 462 and may act as a gating system. The evaluating system 460 may evaluate the likely behavior and reaction times of the driver 20, and may output this information 470.

Generally speaking, therefore, raw data from the sensors 30, 50, 70 of the environment interface 410 are filtered in the recognition preprocessor 420 in accordance with assigned importance, resulting in sensed information being categorized as foreground or background related and then ranked in terms of importance. Thus, by way of example, a detected STOP sign is assigned a higher importance than a detected advertising board. In some examples tree structures may be used for mapping the hierarchical relationships between sensor inputs.

A feature of some examples is that they may be self learning and may get to know the driver's reactions and may predict problems before they occur.

The process shown in FIG. 5 is one implementation. It will be appreciated that other implementations may use a different series of operations.

The output 470 of the evaluator 460 may be a warning to the driver 20 or a semi-autonomous control of the vehicle 40 such as automatic braking, for example, or even a warning to the surrounding environment 60, such as automatic flashing of the headlights or sounding of the vehicle's horn, for example, to warn other drivers and pedestrians.

In some examples, the driver-assistance system 100 in general and the driver state module 120 in particular may be implemented with a dedicated or a general purpose processor. The frame memory 430, the working memory 450(126) comprising a foreground sub-memory 128 and a background sub-memory 130 may be implemented using a variety of memory technologies, such as volatile memories. The learned driver characteristics may preferably be stored in a more permanent memory. The memories may utilize computer-readable or processor-readable non-transitory storage media, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, flash memories or any other type of media suitable for storing electronic instructions.

Examples may include apparatuses for performing the operations described herein. Such apparatuses may be specially constructed for the desired purposes, or may comprise computers or processors selectively activated or reconfigured by a computer program stored in the computers. Such computer programs may be stored in a computer-readable or processor-readable non-transitory storage medium, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions. It will be appreciated that a variety of programming languages may be used to implement the teachings of the invention as described herein. Examples of the invention may include an article such as a non-transitory computer or processor readable non-transitory storage medium, such as for example a memory, a disk drive, or a USB flash memory encoding, including or storing instructions, e.g., computer-executable instructions, which when executed by a processor or controller, cause the processor or controller to carry out methods disclosed herein. The instructions may cause the processor or controller to execute processes that carry out methods disclosed herein.

Different examples are disclosed herein. Features of certain examples may be combined with features of other examples; thus certain examples may be combinations of features of multiple examples. The foregoing description of the examples of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. A driver state module for interfacing with a vehicle, with a surrounding vicinity of the vehicle and with a driver of the vehicle, the driver state module comprising:
(i) a frame memory for storing representations of behaviors with related context;
(ii) an evaluation system for ranking the frames based on goals and rewards;
(iii) a working memory comprising
a foreground sub-memory, a background sub-memory, and a control for sorting frames into the foreground sub-memory or the background sub-memory; and
(iv) a recognition processor for identifying salient features relevant to a frame in the foreground sub-memory or the background sub-memory ranked highest by the evaluation system.

2. The driver state module of claim 1, configured for modeling focus of attention and awareness of the driver and for predicting imminent actions of the driver.

3. The driver state module of claim 1 wherein said interfacing with the vehicle, the surrounding vicinity of the vehicle and the driver of the vehicle is via sensors.

4. A vehicle comprising the driver state module of claim 1.

5. A driver assistance system for assisting a driver of a vehicle within a surrounding vicinity of the vehicle, the driver assistance system comprising:
(i) the driver state module of claim 1;
(ii) a vehicle state module for describing state of the vehicle in the surrounding vicinity;
(iii) a mismatch detection module for comparing the driver state module and the vehicle state module and for assessing whether there is a mismatch between the driver state module and the vehicle state module;
(iv) a driver associate interface module for determining a required action if the vehicle state module detects a mismatch, and
(v) a sensor pre-processing module for fusing data from a plurality of sensors on the vehicle and for outputting fused data in formats appropriate to each module.

6. The driver assistance system of claim 5, wherein the driver state module comprises:
(i) a frame memory for storing representations of behaviors with related context;
(ii) an evaluation system for ranking the frames based on goals and rewards;
(iii) a working memory comprising
a foreground sub-memory, a background sub-memory, and a control for sorting frames into the foreground sub-memory or the background sub-memory; and
(iv) a recognition processor for identifying salient features relevant to a frame in the foreground sub-memory or background sub-memory ranked highest by the evaluation system.

7. The driver assistance system of claim 6 configured for an application including at least one of:
(i) controlling the vehicle for short periods of time whilst the driver is distracted;
(ii) semi-autonomously controlling of the vehicle;
(iii) receiving feedback from driver behavior for self-learning by experience;
(iv) learning driving characteristics of a particular driver to optimize response to the particular driver,
(v) modeling focus of attention and awareness of the driver and
(vi) predicting imminent actions of the driver.

8. The driver assistance system of claim 5 wherein said plurality of sensors comprises at least one vehicle sensor for sensing vehicle related parameters.

9. The driver assistance system of claim 8 wherein the at least one vehicle sensor is selected from the group consisting of speed gauges, engine temperature gauges, fuel gauges, rev counters, sensors that note whether windscreen wipers are deployed, sensors that note whether lights are deployed, sensors that note whether hazard systems are deployed, and sensors that note the position of the steering wheel.

10. The driver assistance system of claim 5 wherein said plurality of sensors comprises at least one driver sensor for sensing driver related parameters.

11. The driver assistance system of claim 10 wherein said at least one driver sensor is selected from the group the group consisting of sensors for sensing the driver's awareness, cameras providing feedback of driver's alertness from nodding, cameras providing feedback of driver's alertness from eye closing, eye trackers for tracking driver's attention from direction of gaze, steering wheel mounted pressure sensors, galvanic skin response sensors for monitoring perspiration and electroencephalography sensors.

12. The driver assistance system of claim 5 wherein said plurality of sensors comprises at least one vicinity sensor for sensing variables relating to a surrounding vicinity of the vehicle.

13. The driver assistance system of claim 12 wherein said at least one vicinity sensor is selected from the group from the group consisting of forward looking cameras, lane following sensors, distance sensors deployed in all directions to determine distance of nearby objects, radar, sonar, IR sensors, general position sensors, GPS, ambient temperature sensors and ambient light sensors.

14. The driver assistance system of claim 5 configured for use in at least one application selected from the group consisting of semi-autonomous control, accident prevention, alerting, education, driver simulation and vehicle design optimization.

15. A vehicle comprising the driver assistance system of claim 5.

16. A computer software product that includes a medium readable by a processor, the medium having stored thereon:
(i) a first set of instructions for storing representations of behaviors with related context as frames in a memory;
(ii) a second set of instructions for ranking the frames based on goals and rewards;
(iii) a third set of instructions for holding and sorting the frames into foreground frames and background frames, and
(iv) a fourth set of instructions for identifying salient features relevant to a foreground frame having a highest ranking.

17. A computer software product that includes a medium readable by a processor, the medium having stored thereon a set of instructions for assisting a driver of a vehicle within a surrounding vicinity of the vehicle, comprising:
(a) a first set of instructions which, when loaded into main memory and executed by a processor models focus of attention and awareness of the driver for predicting imminent actions of the driver;
(b) a second set of instructions which, when loaded into main memory and executed by a processor describe the state of the vehicle in the surrounding vicinity;
(c) a third set of instructions which, when loaded into main memory and executed by a processor describe comparing results obtained from the first and second sets of instructions for assessing whether there is a mismatch requiring further action;
(d) a fourth set of instructions which, when loaded into main memory and executed by a processor determine the required action if running the third set of instructions detects a mismatch, and
(e) a fifth set of instructions which, when loaded into main memory and executed by a processor, fuse data from a plurality of sensors on the vehicle and outputs the fused data in formats appropriate to each of first, second, third and fourth sets of instructions.

18. A method for interfacing with a vehicle, with a surrounding vicinity of the vehicle and with a driver of the vehicle, comprising:
(i) storing representations of driver behaviors with related context as frames in a frame memory;
(ii) ranking the frames based on goals and rewards;
(iii) holding and sorting frames into foreground and background frames within a working memory, and
(iv) identifying salient features relevant to the frame with a highest ranking.

19. A method for processing sensor inputs from a plurality of sensors on a vehicle relating to a driver, the vehicle and a surrounding vicinity, comprising:
(b) fusing data from the plurality of sensors and outputting the fused data in appropriate formats;
(i) modeling focus of attention and awareness of the driver for predicting imminent actions of the driver,
(ii) describing a state of the vehicle in the surrounding vicinity;
(iii) comparing results obtained from the predicted imminent actions and the state of the vehicle to determine mismatches;
(iv) assessing whether there is a mismatch requiring further action, and
(v) determining the required action if a mismatch is detected.
